(19) United States
(12) Patent Application Publication
(10) Pub. No.: US 2003/0025279 A1
(43) Pub. Date: Feb. 6, 2003

(54) Waterproof plug for waterproof connector

(75) Inventor: Osamu Sugiyama, Haibara-gun (JP)

Correspondence Address: SUGHRUE MION, PLLC, 2100 PENNSYLVANIA AVENUE, N.W., WASHINGTON, DC, 20037, US

(73) Assignee: YAZAKI CORPORATION

(21) Appl. No.: 10/208,792

(22) Filed: Aug. 1, 2002

(30) Foreign Application Priority Data
Aug. 1, 2001 (JP) P2001-233741

(51) Int. Cl. F16J 15/02

(52) U.S. Cl. 277/628

(57) ABSTRACT

A cavity having a first diameter is formed in a waterproof connector housing. A cylindrical body portion of a waterproof plug is formed with a plurality of ribs on an outer periphery thereof such that each root portion between the ribs has a second diameter. A cylindrical first extended portion extends continuously from a rib situated at a first longitudinal end of the body portion by a first length. The first extended portion has a third diameter. A cylindrical second extended portion extends continuously from a rib situated at a second longitudinal end of the body portion by a second length. The second extended portion has a fourth diameter, The first extended portion is first inserted into the cavity. The third diameter is equal to or less than the first diameter. The third diameter is equal to or less than the first length.

### BACKGROUND OF THE INVENTION

The present invention relates to a waterproof plug for a waterproof connector, and more particularly to the waterproof plug which is adapted to be press-fitted into the waterproof connector to prevent water from intruding therein.

As shown in FIG. 8, in a first related-art waterproof connector 60 to be employed in a wire harness for a motor car and so on, a terminal 63 is housed in its cavity 61, and an electric wire 64 is connected to the terminal 63. In order to obtain waterproof performance between an inner peripheral face 62 of the cavity 61 and the electric wire 64, a waterproof plug 65 is disposed in the cavity 61.

On the other hand, into the cavity 61 of the waterproof connector 60 at a position to which a wire harness is not mounted, there is employed a closing-type waterproof plug to be press-fitted in order to prevent intrusion of water into the cavity 61.

As the closing-type waterproof plug, the one disclosed in Japanese Design Registration Publication No. 1013727S (second related art) has been known. This waterproof plug of the second related art includes, as shown in FIG. 9, a main body 90 in a substantially cylindrical shape, extended portions 91, 92 extended from opposite ends thereof in an axial direction, and a plurality of ribs 93 provided on an outer peripheral face of the main body 90. The ribs 93 are respectively formed so as to be brought into pressure-contact with an inner peripheral face of a cavity, and the extended portions 91, 92 are formed so as to be slightly brought into pressure-contact or slidably contacted with the inner peripheral face of the cavity.

Moreover, in this second related art, an axial length L of the extended portions 91, 92 is set to be less than a half of their diameter D.

According to the second related art having such a structure, since the extended portions 91, 92 are provided at the opposite ends of the main body 90, when one of the extended portions 91 is inserted into the cavity, the other extended portion 92 is pushed in an axial direction by a finger 94 or the like of an operator, so that the main body 90 is guided by the one extended portion 91 and easily allowed to be press-fitted into the cavity.

By the way, in recent years, an automatic inserting machine has become introduced as means for mounting terminals and waterproof plugs to the waterproof connector. The terminals can be easily pinched by the automatic inserting machine because of presence of the electric wires and the terminals. Also in the second related art, the extended portions 91, 92 can be easily press-fitted into the cavity.

However, in the second related art, because the axial length L of the extended portions 91, 92 is less than a half of their diameter D, it has been difficult for the automatic inserting machine to pinch the extended portions 91, 92, and moreover, there has been such probability that the waterproof plug may fall from the cavity before it is press-fitted into the cavity, after the pinching of the automatic inserting machine has been released.

In contrast, a third related-art waterproof plug 97 as shown in FIG. 10 has a rod-like base body 98 connected thereto, and therefore, the automatic inserting machine can hold this rod-like base body 98 to insert it into the cavity (disclosed in Japanese Utility Model Publication No. 2-3674U).

However, there have been such problems that the third related art is composed of two components, namely the waterproof plug 97 and the rod-like base body 98, resulting in high production cost and high assembling cost, and that application to the automatic inserting machine is difficult due to its direction-dependency.

### SUMMARY OF THE INVENTION

It is therefore an object of the present invention to provide such a waterproof plug for a waterproof connector which is prevented from falling on the way of inserting operation, can be produced at reduced cost, and can be easily applied to an automatic inserting machine.

In order to achieve the above object, according to the present invention, there is provided a waterproof plug for sealing a cavity having a first diameter, which is formed in a waterproof connector housing, comprising:

a cylindrical body portion, formed with a plurality of ribs on an outer periphery thereof such that each root portion between the ribs has a second diameter;

a cylindrical first extended portion, extending continuously from a rib situated at a first longitudinal end of the body portion by a first length, the first extended portion having a third diameter; and

a cylindrical second extended portion, extending continuously from a rib situated at a second longitudinal end of the body portion by a second length, the second extended portion having a fourth diameter, wherein:

the first extended portion is first inserted into the cavity;

the third diameter is equal to or less than the first diameter; and

the third diameter is equal to or less than the first length.

In this configuration, self-retention of the first extended portion can be maintained with respect to the cavity, even though a pinch of an automatic inserting machine is released after it has been inserted into the cavity.

Moreover, because the waterproof plug can be composed of one component, an increase of the cost can be avoided.

Preferably, the fourth diameter is equal to or less than the second length, and the third diameter is equal to the fourth diameter.

Because both of the extended portions have the same diameter and the same axial length with respect to each other, the waterproof plug can be prevented from falling whichever one of the extended portions may be inserted into the cavity, when the waterproof plug is intended to be inserted into the cavity. For this reason, there is no need of considering the direction-dependency of the waterproof plug when it is to be used, and the waterproof plug can be easily applied to the automatic inserting machine.

Preferably, the second diameter is equal to the third diameter. Alternatively, the second diameter may be different from the third diameter.

Because there are provided a plurality of the ribs, the plurality of the ribs can be brought into pressure-contact with the inner face of the cavity, and waterproof performance can be enhanced.

Moreover, because the diameter of the root between the ribs is made different from the diameter of the extended portions, it is possible to optionally select the diameter of the root according to use of the waterproof plug, and the ribs can be efficiently brought into pressure-contact with the inner face of the cavity.

For example, if the second diameter is smaller than the third diameter, deformation of the ribs can be absorbed by the roots between the ribs, when the ribs are brought into pressure-contact with the inner face of the cavity. Consequently, the ribs can be reliably brought into pressure-contact with the inner face of the cavity.

Alternatively, if the second diameter is larger than the third diameter, the main body in addition to the ribs can be also brought into pressure-contact with the inner face of the cavity when the ribs are brought into pressure-contact with the inner face of the cavity.

Alternatively, the third diameter may be smaller than the fourth diameter. Here, it is preferable that the second diameter is larger than the third diameter but smaller than the fourth diameter.

Still alternatively, the third diameter may be larger than the fourth diameter. Here, it is preferable that the second diameter is smaller than the third diameter but larger than the fourth diameter.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a side view of a waterproof plug for a waterproof connector according to a first embodiment of the present invention;

FIG. 2 is a view for explaining a manner in which the waterproof plug shown in FIG. 1 is inserted into a cavity;

FIG. 3 is a view for explaining a state in which the waterproof plug shown in FIG. 1 has been inserted into the cavity;

FIG. 4 is a side view of a waterproof plug for a waterproof connector according to a second embodiment the present invention;

FIG. 5 is a view for explaining a manner in which the waterproof plug shown in FIG. 4 is inserted into a cavity;

FIG. 6 is a view for explaining a state in which the waterproof plug shown in FIG. 4 has been inserted into the cavity;

FIG. 7 is a side view of a waterproof plug for a waterproof connector according to a third embodiment of the present invention;

FIG. 8 is a sectional view showing a first related-art waterproof plug for a waterproof connector;

FIG. 9 is a side view showing a second related-art waterproof plug; and

FIG. 10 is a sectional view showing a third related-art waterproof plug.

### DETAILED DESCRIPTION OF THE PREFERRED EMBODIMENTS

Preferred embodiments of the present invention will be described in detail with reference to the accompanying drawings.

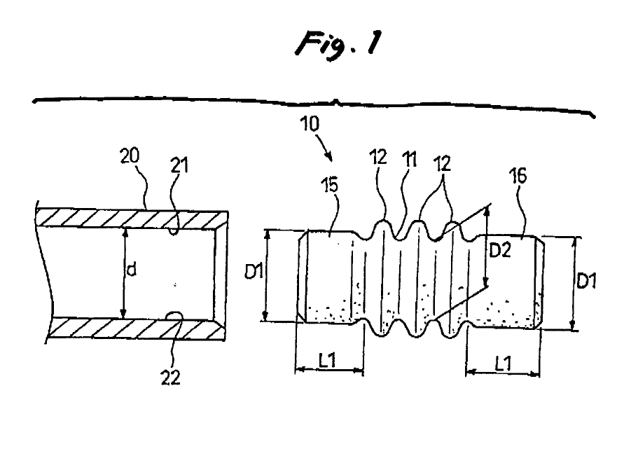

As shown in FIG. 1, a waterproof plug 10 according to a first embodiment of the present invention has a main body 11 formed in a cylindrical shape and provided with ribs 12 along its outer peripheral face, in order to close a cylindrical cavity 21 which is formed in a housing 20 of a waterproof connector, and extended portions 15, 16 in a columnar shape provided at opposite ends of the main body 11 in an axial direction. The ribs 12 are so constructed that they can be brought into a press-contact with an inner peripheral face 22 of the cavity 21.

In addition, in the waterproof plug 10 of this waterproof connector, the extended portions 15, 16 have such a diameter D1 and an axial length L1 that it can be self-retained with respect to the cavity 21, when at least one of the extended portions 15, 16 has been press-fitted into the cavity 21.

It is to be noted that in the first embodiment, description will be made with reference to a case in which both the extended portion 15 and the extended portion 16 have the same diameter D1 and the same axial length L1.

This waterproof plug 10 is composed of one component, and so, an increase of the cost can be avoided.

Relation between the diameter D1 of the extended portions 15, 16 and an inner diameter d of the cavity 21 is set so as to satisfy D1≦d.

Moreover, the main body 11 is provided with a plurality of (three) ribs 12, and a diameter of a root between the ribs 12 is set to be D2, which is the same as the diameter D1 of the extended portions 15, 16.

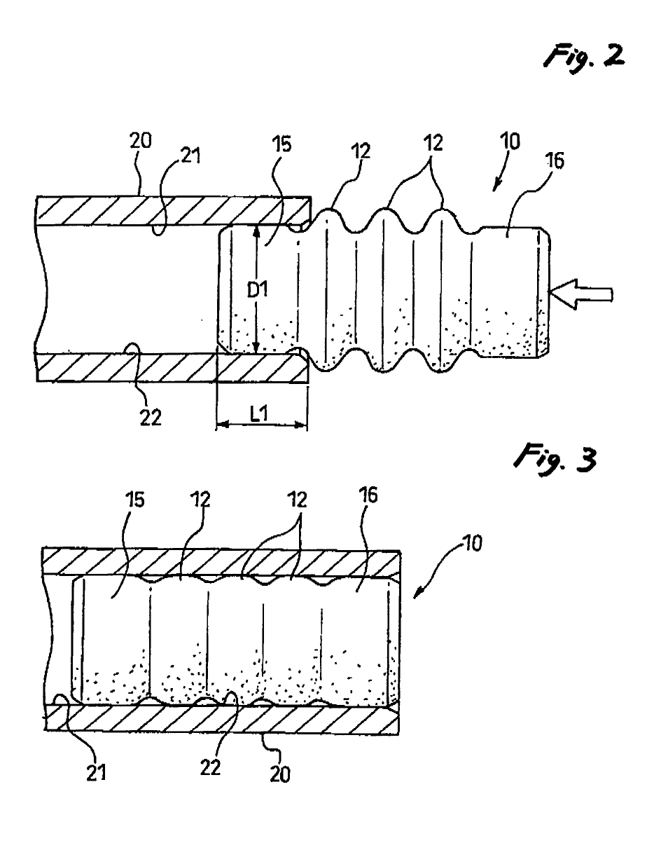

Then, referring to FIGS. 2 and 3, a case in which the waterproof plug 10 is inserted into the cavity 21 will be described.

As a first step, the other extended portion 16 of the waterproof plug 10 is pinched by an automatic inserting machine (not shown), and the one extended portion 15 is inserted into the cavity 21, as shown in FIG. 2. Then, the automatic inserting machine is removed from the other extended portion 16. Because the one extended portion 15 has the diameter D1 and the axial length L1 such that it can be self-retained with respect to the cavity 21, the waterproof plug 10 will not fall from the cavity 21, even though the automatic inserting machine has been removed from the waterproof plug 10.

By pushing the waterproof plug 10 in this state into the cavity 21 with an aid of the automatic inserting machine, as shown in FIG. 3, the cavity 21 will be kept in a seated state having the ribs 12 brought into pressure-contact with the inner face 22 of the cavity 21.

On this occasion, since the axial length L1 of the other extended portion 16 is set to be relatively long, the ribs 12 can be inserted into an extreme depth of the cavity 21 so that the press-fitted state can be favorably maintained.

According to the first embodiment, because the extended portions 15, 16 have the same diameter D1 and the same axial length L1, the waterproof plug 10 can be inserted into the cavity 21 from either of the extended portions 15 and 16 when the waterproof plug is intended to be inserted into the cavity 21.

And that, the drop of the waterproof plug 10 can be avoided, whichever one of the extended portions 15, 16 may be inserted into the cavity 21. For this reason, there is no need of considering the direction-dependency of the waterproof plug 10 when it is to be used, and the waterproof plug can be easily applied to the automatic inserting machine.

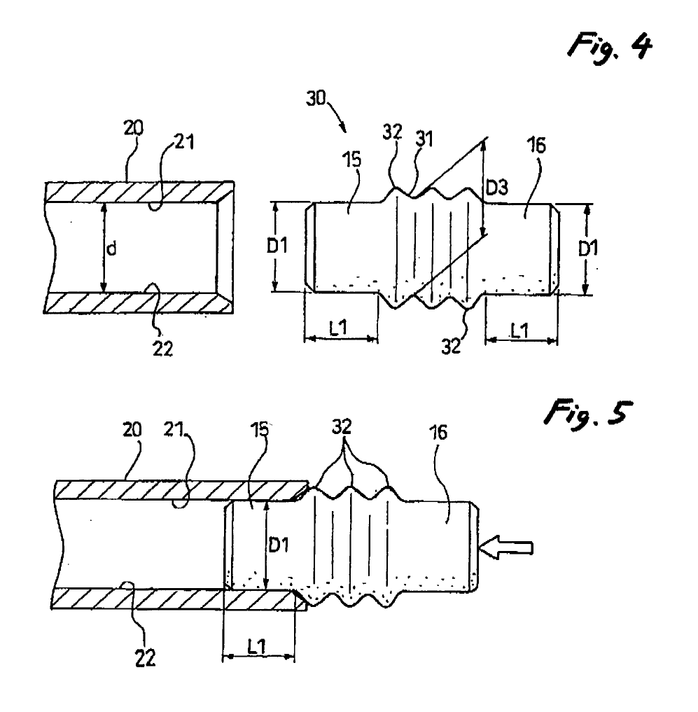

Then, referring to FIGS. 4 to 6, a waterproof plug according to a second embodiment of the invention will be described.

As shown in FIG. 4, a waterproof plug 30 of a waterproof connector in the second embodiment according to the present invention has a plurality of (three) ribs 32 provided on a main body 31, and has substantially the same structure as in the first embodiment, except that it is different from the first embodiment in that a diameter D3 of roots between the ribs 32 is made different from the diameter D1 of the extended portions 15, 16. The parts identical with the first embodiment are designated by the same reference numerals and their detailed explanation will be omitted.

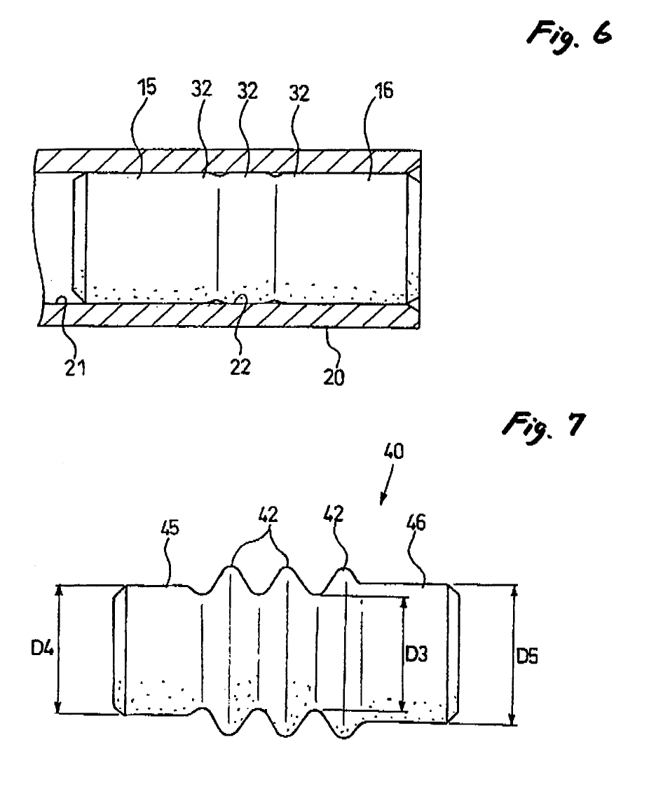

When this waterproof plug 30 is inserted into the cavity 21, the other extended portion 16 of the waterproof plug 30 is pinched by the automatic inserting machine as a fist step, and then, the one extended portion 15 is inserted into the cavity 21, as shown in FIG. 6. Secondly, after the automatic inserting machine has been removed from the other extended portion 16, the waterproof plug 10 is pushed into the cavity 21 with an aid of the automatic inserting machine, as shown in FIG. 6 to bring the ribs 32 into pressure contact with the inner face 22 of the cavity 21, thereby maintaining the cavity 21 in a sealed state.

According to the second embodiment, the same advantage as in the first embodiment can be obtained, and in addition, due to provision of a plurality of the ribs 32, the plurality of the ribs 32 can be brought into pressure-contact with the inner face 22 of the cavity 21, and thus, the waterproof performance can be enhanced.

Moreover, by making the diameter D3 of the roots between the ribs 32 different from the diameter D1 of the extended portions 15, 16, the diameter D3 of the roots can be optionally selected according to the use of the waterproof plug 30. As the results, it will be possible for the ribs 32 to be efficiently brought into pressure-contact with the inner face 22 of the cavity 21, and the waterproof performance can be enhanced.

Specifically, by making the diameter D3 of the roots smaller than the diameter D1 of the extended portions 15, 16, deformation of the ribs 32 can be absorbed by the roots between the ribs 32, when the ribs 32 are brought into pressure-contact with the inner face 22 of the cavity 21. Consequently, as the ribs 32 are reliably brought into pressure-contact with the inner face 22 of the cavity 21, the waterproof performance can be enhanced.

On the other hand, by making the diameter D3 of the roots larger than the diameter D1 of the extended portions 15, 16, when the ribs 32 have been brought into pressure-contact with the inner face 22 of the cavity 21, the main body 31 in addition to the ribs 32 can be also brought into pressure-contact with the inner face 22 of the cavity 21, and the waterproof performance can be enhanced.

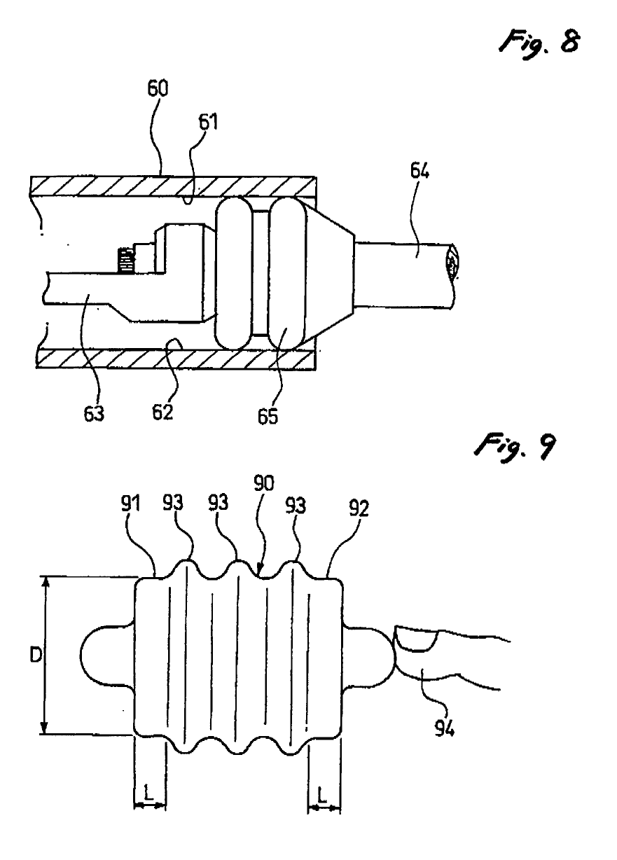

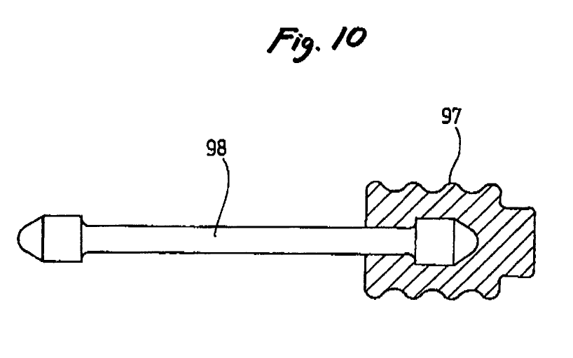

A waterproof plug according to a third embodiment will be described referring to FIG. 7. The parts identical with the first embodiment are designated by the same reference numerals and their detailed explanation will be omitted.

As shown in FIG. 7, a waterproof plug 40 of a waterproof connector in the third embodiment according to the present invention has substantially the same structure as in the first embodiment, except that it is different from the first embodiment in that a diameter D4 of one of extended portions 45 is made smaller than a diameter D3 of roots between the ribs 42, while a diameter D5 of the other extended portion 46 is made larger than the diameter D3 of the roots between the ribs 42.

According to the third embodiment, the same advantage as in the first embodiment can be obtained. In addition, since the diameter D3 of the roots between the ribs 42, the diameters D4 and D5 of the extended portions 45 and 46 are made different from one another, the waterproof plug 40 can be formed in a favorable shape suitable for its use. In this manner, the waterproof performance and convenience for handling can be improved.

It is to be noted that the present invention is not limited to the above described embodiments, but appropriate modifications and improvements can be made, and that material, shapes, sizes, manners, numbers, positions to be arranged, thickness, etc. of the main body, ribs, extended portions and so on exemplified in the above described embodiments can be optionally selected, but not limited, provided that the present invention can be achieved.

What is claimed is:

1. A waterproof plug for sealing a cavity having a first diameter, which is formed in a waterproof connector housing, comprising:
a cylindrical body portion, formed with a plurality of ribs on an outer periphery thereof such that each root portion between the ribs has a second diameter;
a cylindrical first extended portion, extending continuously from a rib situated at a first longitudinal end of the body portion by a first length, the first extended portion having a third diameter; and
a cylindrical second extended portion, extending continuously from a rib situated at a second longitudinal end of the body portion by a second length, the second extended portion having a fourth diameter, wherein:
the first extended portion is first inserted into the cavity;
the third diameter is equal to or less than the first diameter; and
the third diameter is equal to or less than the first length.

2. The waterproof plug as set forth in claim 1, wherein the fourth diameter is equal to or less than the second length.

3. The waterproof plug as set forth in claim 2, wherein the third diameter is equal to the fourth diameter.

4. The waterproof plug as set forth in claim 3, wherein the second diameter is equal to the third diameter.

5. The waterproof plug as set forth in claim 3, wherein the second diameter is smaller than the third diameter.

6. The waterproof plug as set forth in claim 3, wherein the second diameter is larger than the third diameter.

7. The waterproof plug as set forth in claim 1, wherein the third diameter is smaller than the fourth diameter.

8. The waterproof plug as set forth in claim 7, wherein the second diameter is larger than the third diameter but smaller than the fourth diameter.

9. The waterproof plug as set forth in claim 1, wherein the third diameter is larger than the fourth diameter.

10. The waterproof plug as set forth in claim 9, wherein the second diameter is smaller than the third diameter but larger than the fourth diameter.
